(19) United States
(12) Patent Application Publication
(10) Pub. No.: US 2009/0011115 A1
(43) Pub. Date: Jan. 8, 2009

(54) Edible Pullulan Films Containing Flavoring

(76) Inventors: Carter D. Foss, Brentwood, TN (US); Andrew Hoffman, Mount Zion, IL (US); Shiji Shen, Forsyth, IL (US); Adrienne Michele Stucky, Decatur, IL (US); Judy Lynn Turner, Decatur, IL (US)

Correspondence Address: WILLIAMS, MORGAN & AMERSON, P.C., 10333 RICHMOND, SUITE 1100, HOUSTON, TX, 77042, US

(21) Appl. No.: 12/045,132

(22) Filed: Mar. 10, 2008

Related U.S. Application Data
(60) Provisional application No. 60/894,482, filed on Mar. 13, 2007.

(51) Int. Cl. A23L 1/221; A23L 1/237

(52) U.S. Cl. 426/649; 426/650

(57) ABSTRACT

An edible film comprises at least one flavoring, pullulan, and at least one plasticizer. The at least one plasticizer is present in an amount that is effective to prevent the film from becoming brittle. Pullulan makes up greater than 50% by weight of the non-flavoring solids in the film. The film can be contacted with a food to provide flavoring in or on the food.

This application claims priority from U.S. provisional patent application Ser. No. 60/894,482, filed on Mar. 13, 2007, which is incorporated herein by reference.

### BACKGROUND OF THE INVENTION

Edible films have been made from film-forming polymers such as pullulan. For example, edible strips containing pullulan and a breath-freshening agent have been sold for human consumption. Cough suppressants, vitamins, and dietary supplements have also been supplied in the form of edible strips.

Pullulan has a number of properties that make it suitable for use in edible compositions. However, one problem with pullulan films is their limited ability to bend and elongate without breaking. This problem limits the usefulness of pullulan films in many applications.

There is a need for improved edible films that are suitable for various uses.

### SUMMARY OF THE INVENTION

One aspect of the present invention is an edible film that comprises at least one flavoring, pullulan, and at least one plasticizer. The at least one plasticizer is present in an amount that is effective to prevent the film from becoming brittle. Pullulan makes up greater than 50% by weight of the non-flavoring solids in the film.

Another aspect of the invention is a method of adding at least one flavoring to a food. The method comprises contacting the food with an edible film as described above.

### DESCRIPTION OF SPECIFIC EMBODIMENTS

An edible film can comprise at least one flavoring, pullulan, and at least one plasticizer. “Flavoring” is used in a broad sense in this patent, and is intended to include seasonings, spices, and herbs, as well as compositions that are commonly referred to as “flavorings” in the food industry. “Flavoring” is also intended to include flavored sauces, concentrates, and the like that contain at least one seasoning, spice, herb, and/or flavoring. Barbeque sauce is one example of such a flavored sauce.

Pullulan makes up greater than 50% by weight of the non-flavoring dry solids in the film. In other words, if the flavoring and water that are present in the film are excluded, pullulan makes up greater than 50% by weight of the remaining components of the film. In one embodiment of the invention, pullulan makes up greater than 60% by weight of the non-flavoring solids in the film. In another embodiment, the film comprises about 20-80% by weight pullulan on a dry solids basis.

Pullulan forms strong films that readily melt and dissolve when exposed to moisture. It should be understood that many if not all films made as described herein would generally be considered water-soluble, but they may not totally dissolve in all food applications. The film can optionally also include one or more film forming polymers other than pullulan. For example, the film can also contain polymers such as alginates, carrageenans, xanthan gum, modified cellulose, polydextrose, starch or a starch derivative (such as dextrin or maltodextrin), and combinations of two or more such materials. Inclusion of one or more of these polymers can enhance film strength and solubility and reduce cost as compared to compositions that contain only pullulan as a film-forming ingredient.

The film also contains at least one plasticizer, in an amount sufficient to prevent the film from being brittle. Suitable plasticizers include, but are not limited to glycerol, sorbitol, propylene glycol, polyethylene glycol, corn syrup, high fructose corn syrup, fructose, fruit juice, sucrose, maltodextrin, corn syrup solids, polydextrose, soluble fiber, and combinations of any of these materials. In one embodiment of the invention, the at least one plasticizer is selected from glycerol, propylene glycol, sorbitol, and polyethylene glycol. One commercially available polyethylene glycol that is suitable for use in the invention is polyethylene glycol molecular weight 200 (PEG 200). In another embodiment, the film comprises at least two of glycerol, fructose, and sorbitol. In yet another embodiment, the film comprises glycerol, fructose, and sorbitol.

In some embodiments of the invention, the flavoring will be a composition that contains plasticizer, such as a BBQ sauce, for example, and it will not be necessary to add separate plasticizer to the composition. Thus, in some embodiments of the invention, the plasticizer is part of the flavoring, while in other embodiments, the plasticizer is not part of the flavoring.

In general, pullulan-containing films that also contain plasticizers exhibit increased strength and elongation compared to pullulan films that do not contain plasticizers, up to a point. However, increasing the plasticizer content of a pullulan film beyond this level often leads to greatly decreased tensile strength. Surprisingly, it has been found that pullulan compositions that include at least two of the plasticizers glycerol, propylene glycol, sorbitol, and polyethylene glycol can be used to produce pullulan films that have high elongation and high tensile strength, even at relatively high plasticizer concentrations. In at least some embodiments of the invention, the film can be elongated at least about 50%, and in some cases at least about 100%, without breaking. In certain embodiments, the elongation without breaking is at least about 200%, or at least about 300%. In some embodiments of the invention, these enhancements to the elongation properties of the film are achieved without a substantial reduction in tensile strength.

Plasticizer concentration and type can influence the dissolution rate of the film, and the composition used to make the film can be optimized to meet the requirements of a specific application. Other polysaccharides can also influence the dissolution rate of the film. For example, as mentioned above, the film can contain various amounts of modified food starches, such as acid thinned or hydroxypropyl (HP) substituted starch (including, for example, potato, dent corn, waxy corn, and/or tapioca starch), or maltodextrin. Various types of soluble and insoluble fiber can also be included to improve the dissolution rate of the film, such as saccharide oligomers, insulin, polydextrose, and dextrin.

Optionally, the composition can also comprise at least one salt. It has been found that the addition of salt to the film improves its elongation. Typically, in order to improve elongation, surface properties are sacrificed such as blocking and tackiness. However, when salt is included in the composition to increase elongation, surface properties in many instances are improved. Films that contain salt and a suitable level of plasticizer do not block and are not tacky, and therefore can be rolled onto themselves more easily. Examples of suitable salts include NaCl and KCl. In certain embodiments of the invention, the concentration of salt in the film-forming composition is about 0.3-15% by weight on a dry solids basis. Films with a salt content of 10% or greater are cloudy with a powder finish as some of the salt precipitates out of the film to the surface on drying. Films with lower salt content of 5% or less still have good elongation and surface properties without any residual salt precipitating from the films.

It has been found that the addition of salt to the film improves its solubility and dissolution rate. Addition of 0.3-15% salt by weight on a dry solids basis is used to improve dissolution. Suitable salts can include sodium chloride, potassium chloride and magnesium chloride.

As another option, the film-forming composition can comprise at least one internal film release agent, to make it easier to peel the film from a substrate surface on which it is cast. Suitable examples of internal film release agents include, but are not limited to, polyoxyethylene sorbitan monooleate, sodium lauryl sulfate, and combinations thereof. Polyoxyethylene (20) sorbitan monooleate is commercially available as Polysorbate 80.

The film optionally can also contain one or more additives that are suitable for use in foods, such as fillers, surfactants, stabilizers, and organic acids (such as citric acid).

Techniques of forming films using pullulan compositions are well known in the art. For example, an aqueous pullulan composition can be cast onto a flat surface, and then heated and dried to form the film. The films can be prepared in any desired thickness. In some embodiments of the invention, the film will have a thickness between about 0.002 inches and about 0.02 inches. Methods for controlling the thickness of the film are also well known. Soluble or insoluble ingredients can be incorporated in or on the film. Due to the adhesive properties of pullulan, large particulates such as peanuts can be sprinkled on a wet film and when dried will adhere to the surface.

The edible film can be formed by preparing a film-forming composition as described above, coating a substrate (e.g., a stainless steel surface) with a solution or suspension that comprises at least one surfactant, and casting the film-forming composition on the substrate. After suitable heating and/or drying, the film can be peeled from the substrate.

Some film compositions that are cast directly onto a stainless steel substrate do not release well from the steel. These films will often simply stretch out and become distorted when one attempts to remove them from untreated steel. In order to eliminate or reduce this problem, the steel substrate can be treated with solutions or suspensions that comprise release agents.

The coating of the substrate with the solution or suspension of a food grade surfactant (i.e., an external film release agent) makes it easier to peel the film away from the substrate. Suitable surfactants for this purpose include, but are not limited to, propylene glycol monostearate, sodium stearoyl lactylate, polyoxyethylene sorbitan monooleate (e.g., Polysorbate 80), sodium lauryl sulfate, salts of stearic acid, or a combination thereof. Suitable surfactants can be used in quantities up to 10% by weight in solutions of water and/or alcohol (e.g., isopropyl alcohol), or other suitable solvent systems.

The film can contain any one or more flavorings that are suitable for consumption and that can be incorporated into or onto the film. Examples of suitable flavorings include powders that are substantially dry and larger solid particulates. Liquid flavorings can also be used. For example, a film can be made from a flavored sauce (e.g., barbecue sauce) or liquid seasoning by simply incorporating pullulan in the liquid and drawing the composition to form a film. In one embodiment of the invention, the film comprises a premixed combination of two or more flavorings.

Edible films containing the above-described ingredients can have suitable tensile strength, flexibility, and dissolution characteristics for application onto or into food products. For example, the film can be placed on meat, fish, or poultry before, during, or after grilling, baking, or other cooking methods, to form a glaze, or to simply dissolve, leaving the flavoring on the surface of the food. The film can be applied to vegetables before, during, or after steaming or other cooking methods. The film can be added to a sauce pan to deliver flavoring to a sauce, stock or broth. The film can be used in a variety of cooking methods, such as sauteing, stir frying, pan frying, grilling, broiling, roasting, steaming, simmering, braising, and stewing. In order to make the film dissolve more completely and/or more quickly, it is usually helpful to apply steam, for example from a combination oven or by baking the food in a casserole dish with a lid or cover on it.

A film containing a suitable flavoring can be dissolved in water to make a flavored beverage. For example, the film can contain lemon flavor, acid, and sucralose, and when added to water can form sugar-free lemonade.

Films of the present invention can be cut into any desired shape and size, which makes it easy to store and use them. They can take up less space in a restaurant or home pantry than a jar or bottle of a flavoring, and can be portable for on-the-go uses. They can be packed with several films in one outer package, each containing a different flavoring, so that the end user would have variety in one package. For example, one box could contain five different films of varying spices so that one day a cook could make BBQ chicken and the next day lemon-pepper chicken.

The films can produce an even application of flavoring to a food that is visually pleasing to the consumer's eye. The films can also produce costs savings by eliminating the excessive use of flavorings that is inherent in manually shaking or sprinkling a flavoring on a food. The films can also be more convenient than traditional flavorings, for example by having a premixed combination of flavorings present in a single film.

### EXAMPLES

### Preparation of Pullulan and Other Polymer Solutions

The choice of ingredients and concentrations is typically designed so as to produce a polymer solution that will have a viscosity of less than 10,000 centipoises. Pullulan and any other polymers are mixed in a beaker until homogeneous. The water, plasticizers, and other additives are placed in a beaker and agitated with a Servodyne Mixer Head model 50003-30 at 700 rpm for about 1 minute until incorporated. Then the dry polymer powder is added to the vortex of the stirring liquid over time. Stirring at 700-1100 rpm is continued until all the powder is incorporated. The mixer is stopped, the beakers' sides are scraped, and mixing at 1200 rpm is continued for two minutes. The beaker is covered and allowed to sit overnight or centrifuged to remove the air. If ingredients are being used that have low solubility (e.g., citric acid), they can be slowly added before the dry polymer powder is added. If making a glaze film, pullulan can be hand stirred directly into a pre-made sauce.

Incorporation of Flavoring Agents

Liquid flavors and fine powders can be stirred into the pullulan base. Fine powders and larger flavoring particles can also be sprinkled on top of the cast film.

Film Casting and Drying

Aqueous solutions were cast onto 0.003 inch mylar by hand using drawdown bars with a gap of 0.0025-0.08 inches at a rate of about four inches per second. If necessary, the flavoring agents were evenly sprinkled on the film. The films on the mylar were placed into a controlled drying chamber set for 65° C. and 25% relative humidity (RH) for two hours to dry the pullulan films.

### Film Conditioning

Films were conditioned in a controlled drying chamber set for 25° C. and 28% RH overnight. Samples were stored in Hefty® OneZip® slider bags or in foil pouches prior to testing.

Film Testing by Cooking

Samples were tested and evaluated in their appropriate context (grilled or baked chicken breast, beef steak, chicken broth, gravy, etc.) Sample films were tested and evaluated for dissolution, post-cook appearance, taste, and post-cook gumminess. For grilled meats, the meat was seared on one side, flipped, and the film placed on the cooked side. Water was squirted onto the film and the meat was covered to capture steam. Some food samples then completed their cooking in an oven. Baked meats were cooked in a combination steam and convection oven at 300 to 475° F. with 5 to 50% Relative Humidity until proper internal temperature was reached. A conventional oven was used for some samples at 300 to 500° F. For the chicken broth testing, 100 g low-sodium chicken broth was heated on a stove over medium heat until simmering. The film was weighed, added to the simmering broth, and stirred until completely dissolved. Dissolution time and taste were noted.

The following compositions were prepared using the above procedure:

Spice Film

| | |
|---|---|
| % | Grams |

Solids

| | | |
|---|---|---|
| Pullulan | 64.4 | 193.2 |
| Mira Mist 662 modified | 5 | 15 |
| food starch | | |
| Glycerol | 10 | 30 |
| Sorbitol Special | 20 | 60 |
| Polysorbate 80 | 0.5 | 1.5 |
| Sodium Benzoate | 0.1 | 0.3 |
| Total | 100 | 300 |

Film

| | | |
|---|---|---|
| Solids | 30 | 300 |
| Water | 70 | 700 |
| Total | 100 | 1000 |

Spices were added to the film mass or sprinkled on top of wet film. The quantity added was determined by the flavor required.

The following spices were added to samples of a film mass to prepare spice films:

Poultry Magic (Chef Paul Prudhomme's Magic Seasoning Blends)

Tomato Powder (McCormick & Co. 96532)

Honey

Honey and Cinnamon

Creole (Konriko)

Garlic Powder (Abelei-US Ingredients)

The following spices were applied to the surface of films:

Italiano Rub*

Sesame Teriyaki Rub*

Came Mexican Rub*

Montreal

Italian

Peanut

*Elite Spice

A sauce film was prepared containing the following ingredients:

| | % | Grams |
|---|---|---|
| Prepared BBQ Sauce | 80.68 | 80.68 |
| Pullulan | 19.32 | 19.32 |
| Total | 100 | 100 |

Other sauce films were made from the following prepared sauces or liquid concentrates:

KC Masterpiece Premium Original Barbecue Sauce

Soy Sauce

A1 Steak Sauce

A drink flavoring film was prepared with the following ingredients:

| | |
|---|---|
| % | Grams |

Solids

| | | |
|---|---|---|
| Pullulan | 77.37 | 35.32 |
| Star-Dri 1005 maltodextrin | 12.12 | 5.53 |
| Krystar, crystalline fructose | 10.31 | 4.71 |
| Polysorbate 80 | 0.06 | 0.03 |
| Sodium Benzoate | 0.14 | 0.06 |
| Total | 100 | 45.65 |

Film

| | | |
|---|---|---|
| Solids | 19.28 | 45.65 |
| Water | 180.72 | 191.12 |
| total | 100 | 236.77 |
| Lemon Flavor | | 50 |

Flavoring films for beverages were prepared containing the following flavors:

Lemon

Orange

The preceding description of certain embodiments of the invention is not intended to be an exhaustive list of all possible embodiments. Persons skilled in this field will appreciate that modifications could be made to the specific embodiments described herein which would be within the scope of the following claims.

What is claimed is:

1. An edible film, comprising at least one flavoring, pullulan, and at least one plasticizer in an amount effective to prevent the film from becoming brittle, wherein pullulan makes up greater than 50% by weight of the non-flavoring solids in the film.

2. The film of claim 1, wherein pullulan makes up greater than 60% by weight of the non-flavoring solids in the film.

3. The film of claim 1, wherein the film comprises about 20-80% by weight pullulan on a dry solids basis.

4. The film of claim 1, wherein the at least one plasticizer is part of the at least one flavoring.

5. The film of claim 1, wherein the at least one plasticizer is not part of the at least one flavoring.

6. The film of claim 1, wherein the at least one plasticizer is selected from glycerol, sorbitol, propylene glycol, polyethylene glycol, corn syrup, high fructose corn syrup, fructose, fruit juice, sucrose, maltodextrin, corn syrup solids, polydextrose, soluble fiber, and combinations thereof.

7. The film of claim 6, wherein the film comprises at least two of glycerol, fructose, and sorbitol.

8. The film of claim 7, wherein the film comprises glycerol, fructose, and sorbitol.

9. The film of claim 1, further comprising at least one film-forming polymer in addition to pullulan.

10. The film of claim 9, wherein the at least one film-forming polymer is selected from alginates, carrageenans, xanthan gum, modified cellulose, polydextrose, starch, dextrin, maltodextrin, and combinations thereof.

11. The film of claim 1, wherein the flavoring is a dry powdered seasoning.

12. The film of claim 1, wherein the flavoring is a flavored sauce or a liquid seasoning.

13. The film of claim 1, wherein the film comprises a premixed combination of two or more flavorings.

14. The film of claim 1, further comprising at least one salt.

15. The method of claim 14, wherein the at least one salt comprises NaCl.

16. The method of claim 14, wherein the at least one salt is present in the film-forming composition at a concentration of about 0.3-15% by weight on a dry solids basis.

17. The film of claim 1, further comprising an internal film release agent.

18. The film of claim 17, wherein the internal film release agent is selected from polyoxyethylene sorbitan monooleate, sodium lauryl sulfate, and combinations thereof.

19. A method of adding at least one flavoring to a food, comprising contacting the food with an edible film that comprises at least one flavoring, pullulan, and at least one plasticizer in an amount effective to prevent the film from becoming brittle, wherein pullulan makes up greater than 50% by weight of the non-flavoring solids in the film.
